(19) United States
(12) Patent Application Publication
(10) Pub. No.: US 2004/0225604 A1
(43) Pub. Date: Nov. 11, 2004

(54) System for providing a checkless checking account

(76) Inventors: Sheldon H. Foss JR., Suwanee, GA (US); Dennis H. James JR., Atlanta, GA (US)

Correspondence Address: LAVA GROUP LAW BY SMITH & FROHWEIN, LLC, P.O. BOX 88148, ATLANTA, GA, 30356, US

(21) Appl. No.: 10/645,949

(22) Filed: Aug. 22, 2003

Related U.S. Application Data
(60) Provisional application No. 60/466,509, filed on Apr. 29, 2003.

(51) Int. Cl. G06F 17/60

(52) U.S. Cl. 705/39

(57) ABSTRACT

A system and method for providing a checkless checking account is described, illustrated and claimed. The present invention is a system and method for providing a checkless checking account that provides transactional functionality of a branded card wherein the account is funded from the account owner's personal funds. Additionally, the checkless checking account may be combined with a credit component to expand its functionality.

### CROSS REFERENCE TO RELATED APPLICATIONS

This application is related to, and incorporates by reference, U.S. patent application having Ser. No. ______, and entitled “SYSTEM AND METHOD FOR DYNAMICALLY MANAGING A FINANCIAL ACCOUNT” which is filed concurrently herewith and is assigned to the same assignee.

This application claims priority to U.S. Provisional Application No. 60/466,509 filed on Apr. 29, 2003.

### TECHNICAL FIELD

The present invention relates to banking industries and, more particularly, to a system for providing a checkless checking account.

### BACKGROUND OF THE INVENTION

Although the totally cashless society depicted in George Orwell's book titled 1984 has not totally engulfed our culture, everyday we move closer and closer to the realization of this one time futuristic prediction. As our society moves towards cashless operation, it is becoming increasingly important for individuals to be able to obtain some form of credit. The most basic forms of credit are checking accounts and credit card accounts. Traditionally, to obtain a checking account, a customer must meet certain qualifying criteria. Usually the qualification process includes an examination of the customer's past credit history combined with other relevant data such as historical spending habits, levels of income, amount of savings, net worth, or the like. To obtain a credit card account, a similar qualification process must be performed and in some cases, even a more stringent process. For instance, in addition to passing the qualification process for a checking account and/or credit card account, an issuer of such account may further require some form of collateral from the customer, such as a current direct deposit account (DDA), a savings account or some type of credit account. The purpose of the collateral is to cover the check writing or credit privilege accompanied with the account.

Typically, in an effort to mitigate their risks of exposure due to bad checks or the like, banks and other checking account issuing entities require established credit for an applicant. However, a significant percentage of the population cannot meet the minimum qualifying criteria for being approved for a checking account and/or a credit card account. As a result, a large number of individuals must live a cash only life in an increasingly cashless society. For these individuals, they understand the meaning of a catch-22 because to get credit, they have to be credit worthy but to demonstrate credit worthiness, they need to obtain credit. Thus, there is a need in the art for a financial account system that non-credit worthy individuals can qualify for and use to build up a positive credit history.

A checking account is a unique form of a credit account in that traditionally, when writing a check, the funds being extracted are typically not automatically verified, as they are when using a credit card. Thus, a merchant accepting a check as a form of payment may not have the benefit of immediate feedback as to whether the tendering customer has a sufficient balance in his or her account to cover the check. Checks that are cashed against insufficient funds are costly to the merchant and the bank and unfortunately, this cost is passed on to the consumer. One mechanism used to alleviate an insufficient funds situation is by providing overdraft protection. Overdraft protection basically operates like a line of credit. If a customer writes a check that is too large to be covered by funds in the customer's account, the overdraft protection can be activated. This activation generally involves transferring funds into the account to cover the outstanding check, and charging a fee and/or interest to the customer. It is quite obvious that there is an increased risk of loss when an issuing institute provides such a service. Thus, the qualifying requirements for this type of service will typically be even more stringent than the above-described qualifications for obtaining a checking account. However, there is a need in the art for non-credit worthy or border-line credit worthy individuals to have some level of overdraft protection without significantly increasing the risk exposure of the issuing institute.

A significant cost associated with servicing a checking account is processing the cancelled checks and issuing new checks. In fact, recent legislation has been proposed to authorize banking institutes to not return processed checks to account holders. This would greatly reduce the cost associated with servicing a checking account; however, significant expenses will still be incurred in processing the checks. Thus, there is a need in the art for a method to reduce the cost associated with servicing a checking account. Such a cost reduction could help reduce passed down expenses to the consumer.

Thus, there is a need in the art for a checking account system that non-credit worthy individuals can qualify for yet, does not expose the issuing institute to unwarranted risk of loss. There is also a need in the art for a checkless checking card account that eliminates the overhead associated with processing cancelled checks, issuing new checks, etc. There is also a need in the art for a financial account that allows typically non-credit worth individuals to obtain credit in the form of overdraft protection.

### SUMMARY OF THE INVENTION

The present invention is directed to a system for providing a checkless checking account. More specifically, the present invention is a system and method for providing a checkless checking account that typically non-credit worthy individuals can qualify for and that does not expose the issuing institute to unwarranted risk of loss. This solution is in part based on the fact that the account is funded from the account owner's personal funds. Advantageously, the present invention allows a customer who would normally not qualify for a checking account or credit account to have access to cash through a pseudo checking account.

In operation, a customer deposits funds into an account and is issued a card. This is akin to a prepaid card in that a balance is associated with a particular card and the balance can be drawn against. For instance, the customer can then utilize this card during financial transactions and the transactions are drawn against the funds in the customer's account. Because the funds are initially provided by the account owner, the issuing institute is not exposed to a significant amount of risk. Yet, a traceable and use that can be monitored of the checkless checking or credit card type account is provided to allow the account owner to demonstrate credit worthiness. The card utilized for such a service can be branded by a company such as Visa or American Express.

One of the key aspects to the operation of this invention is obtaining the initial funds. This can be accomplished using a variety of techniques. In some embodiments, customers to this service deposit their paychecks directly into the account. The present invention anticipates other techniques for getting funds into the account including, but are not limited to, point of sale transactions where the customer gives cash in exchange for having the account credited, terminal readers such as at gas stations, ATM like machines, depositing cash through a service such as Western Union, over the Internet, or by mailing the check to an account representative.

In an exemplary embodiment of the invention, the value associated with the card or the balance that is within the account resides on a system, or as termed in the art, is host based.

Another aspect of the present invention is the data collection component. The data collection component operates to obtain the data necessary to establish and monitor an account, as well as determining the eligibility and type of the account. Several techniques can be employed to obtain the data and although there are preferred techniques described herein, the present invention should not be limited to any particular technique. One technique to provide this functionality is through a telephone or 1-800 number driven marketing system. Another technique is to collect the information at a point of sale terminal or kiosk. Advantageously this technique has the added capability of collecting the initial deposit of funds at the same time as the data is collected. Regardless of the particular technique employed, the data collected can include, but is not limited to, information such as the customer's name, date of birth, contact information, government identification such as a Social Security Number, financial status, marital status, employment history, references, or the like. In addition, some level of prior behavior such as the customer's insufficient funds history maybe included. The system may also run a credit check on new or renewing customers.

Another aspect of the present invention is the provision of a line of credit or access to a credit or overdraft protection. Advantageously, this aspect of the present invention enables customers that typically would not even qualify for a checking account to have some level of access to a line of credit. In an exemplary embodiment, this aspect of the invention is made available on a checkless checking account only when the customer provides the account service provider the number of and access to a direct deposit account in which the customer's paycheck or other periodic payment is credited. In addition, the customer is required to complete an automated clearing house form and provide the same to the account service provider. These requirements help to mitigate some of the risk of loss for the account service provider. For example, the account service provider may give a $300 line of credit to a customer. If the customer borrows a certain amount of this credit, for example $250, the customer may have to pay the account service provider a fee. The account service provider gives the customer a certain number of days during which to pay off the borrowed amount. If the customer fails to make such payment, the account service provider can deduct the borrowed amount, along with any assessed fee from the direct deposit account of the customer.

An advantage of the present invention is that there are no fees charged for checks and there is no limit to the number of checks that a customer can write during a given period of time.

Another aspect of the present invention is the account creation system. The account creation system includes a stored value component and an overdraft component. Aspects of the present invention are based on the Stored Value Systems that are currently deployed by several credit card processing companies. The general transaction cycle from a merchant's perspective can be found at the following URL: http://www.usa.visa.com/business/merchants/guide to transaction.html?it=h2

The typical stored value system operates to create accounts for the issuance of a card, and provide the settlement and authorization functionalities. The present invention provides a customization or modification to such stored value systems. The modification operates to allow for a linkage to be created between a credit/overpayment component and the stored value component.

The present invention is most likely implemented in cooperation or in partnership with a bank or financial institution. The bank provides a funding account that typically holds 100% of the funds. The funding account operates in conjunction with the Stored Value System to provide notice and receive status in real time. Once a customer is accepted as a customer, the funds are deposited into the funding account. The Stored Value System maintains a master file of all accounts that have been issued, the current balance for each account, what has been posted, what is being held for authorization, etc. When a transaction hits the system, a temporary hold is placed on the account. If settlement does not come through, the hold is released and the funds are available again after a period of time.

Another aspect of the present invention is the account management. The account management performs the day-to-day transactional activity for the present invention. Among other things, these day-to-day activities include the provision of fraud management. Fraud management is provided through prevention, detection and control. Prevention includes creating certain criteria aimed at preventing fraud from occurring. One example of a form of fraud is card stealing. Detection involves taking real-time data and soliciting or calculating a fraud possibility based on such data. Control involves recover of losses after the fact, for example charge-backs.

The account management component also operates to control or alter the behavior or characteristics of an account based at least in part on the outputs of various risk models. In operation, the account manager receives a dump of all accounts and account activity at some period of time, such as during the night. This data is referred to as aggregation data. The data obtained in the dump is examined to identify trends in behaviors. The trends may result in certain actions taking place, for instance, a missed payment may trigger a dialer to be scheduled for the customer or may result in a lock down of further authorizations. Other actions based on the aggregation data can also be performed and the present invention anticipates such actions. Thus, the dumped data is used as the basis for actions that can be taken to limit any, or any further loss.

The risk models operate to gather portfolio data and build predictor models based on usage patterns and balance history or the like. The risk models are used to control the behavior of the account manager.

### BRIEF DESCRIPTION OF THE DRAWINGS

Other aspects, advantages and novel features of the invention will become more apparent from the following detailed description of exemplary embodiments of the invention when considered in conjunction with the accompanying drawings wherein:

FIG. 1 is a flow diagram that illustrates a traditional process used in creating and issuing a checking card bank account.

FIG. 2 is a system diagram illustrating an exemplary application of the present invention.

FIG. 3 is a flow diagram illustrating an exemplary embodiment of the present invention depicting a method for creating an account.

FIG. 4 is a flow diagram illustrating an exemplary embodiment of the present invention depicting a transactional process.

FIG. 5 is a flow diagram illustrating an exemplary embodiment of the present invention depicting a deposit transaction.

### DETAILED DESCRIPTION

In general, the present invention can be described as a novel system and method for providing a checkless checking account. The exemplary embodiments described below are for illustrative purposes only and, a person skilled in the art will construe them broadly. Throughout the detailed description, reference will be made to the operation of the present invention in utilizing the Stored Value Systems that are currently deployed by several credit card processing companies. These systems operate to create accounts for the issuance of a card, and provide the settlement and authorization functionalities. It should be understood that the features and aspects of the present invention can be ported into a variety of systems and system/network configurations and any examples provided within this description are for illustrative purposes only. Referring now to the figures, in which like numerals refer to like elements throughout the several views, exemplary embodiments of the present invention are described.

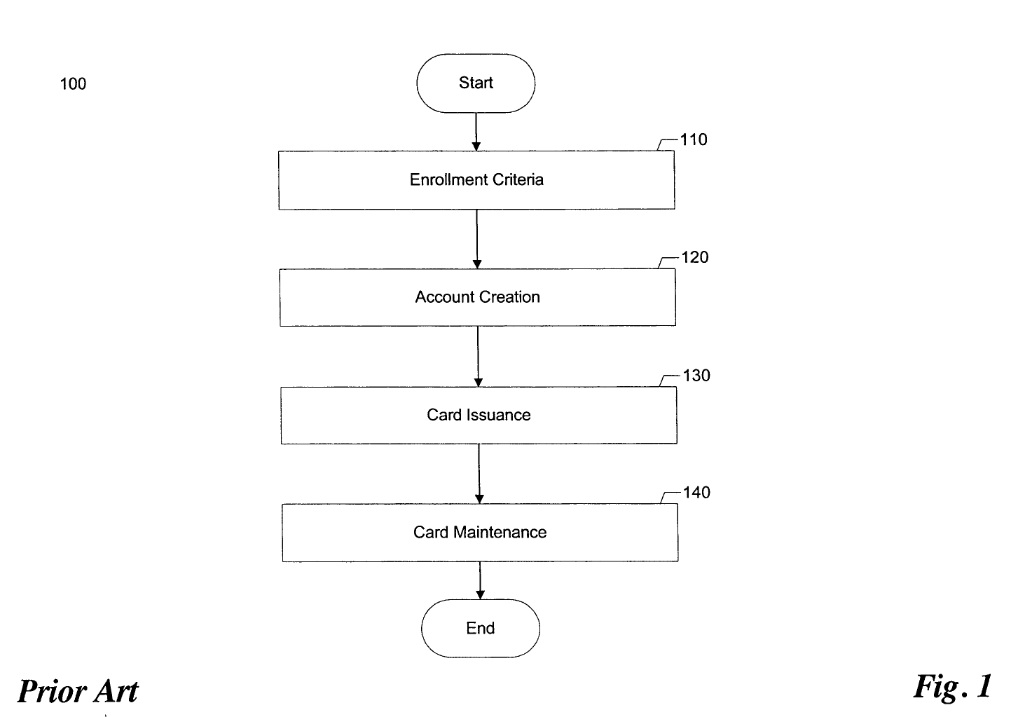

FIG. 1 is a flow diagram that illustrates a traditional process used in creating and issuing a checking card bank account 100 to a customer. The traditional process involves a step to establish Enrollment Criteria 110 followed by the step of Account Creation 120. In the step of establishing Enrollment Criteria 110, qualifiers are analyzed through a risk management process to determine if a potential customer will qualify for an account. Some of the potential qualifiers include, but are not limited to, name, date of birth, address, telephone, social security number, verified government identification, direct deposit account (DDA) information and number, savings account information and number, credit history, debt to credit ratio, assets, etc. These qualifiers are analyzed and/or utilized to obtain further information that can be analyzed regarding the potential customer. In the Enrollment Criteria 110 step, if the potential customer does not pass the risk management process, the potential customer will be denied an account. However, if the potential customer passes the risk management process, the potential customer will become a customer and step of Account Creation 120 will be performed.

In the Account Creation 120 step, the customer is issued an account. The traditional account can be issued with a personal identification number (PIN) type automatic teller machine (ATM) card, or if the customer has met a higher standard during the Enrollment Criteria 110 step a PIN/Signature card may be issued. In either situation, an account or card limit is set to limit the dollar amount of any particular transaction and/or to limit the dollar amount of a transaction in a particular time period as specified by the issuer. After the Account Creation 120 step is complete, the traditional process continues to the Card Issuance 130 step.

In the Card Issuance 130 step, a card is issued to the customer. Typically, the card is sent to the customer's specified address after a period of time determined by the issuer.

Finally, a Card Maintenance 140 step is performed. In the Card Maintenance 140 step, the customer can maintain the account, view current balance, see transactional history or pay the account statement. Typically the Card Maintenance 140 step is performed via mail in the form of paying a statement at a monthly interval or by interacting with the issuer from an automated or live telephone services or a website.

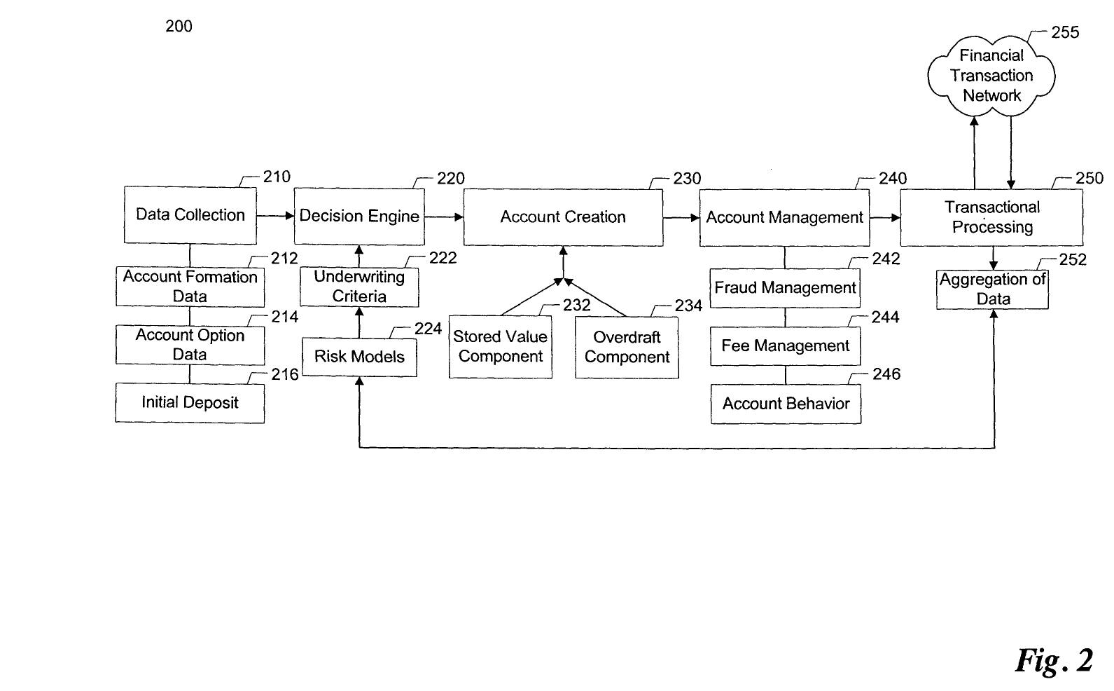

FIG. 2 is a flow diagram 200 illustrating an exemplary embodiment of the present invention. The details of the operation of the flow diagram 200 may vary among various embodiments of the present invention. In general, the illustrated embodiment includes five main functions or components: the data collection component 210, the decision engine 220, the account creation component 230, the account management component 240 and the transactional processing component 250. It should be understood that structure illustrated in this figure is for discussion purposes only and the various functions or components of the present system could be combined or split in many manners.

The data collection component 210 collects data or information relevant to: opening a credit account (account formation data 212), determining if an applicant can qualify for an account, the type of account to be opened (account option data 214), and other miscellaneous data. The information collected with regards to the account formation data 212 may include, but is not limited to, the applicant's name, date of birth, mailing, residential and business addresses, telephone numbers, social security number or verified government identification number, direct deposit account (DDA) information and account number, savings account information and account number, credit history, debt to credit ratio, assets, marital status, employment history etc.

The account option data 214 comprises account option data chosen by the customer, which can be used to determine an account type. In an exemplary embodiment, the account option data 214 may include, but is not limited to, a selection of one of the following account types: instant issue card account, a basic card account and a basic card account with an overdraft component. Additionally, the account option data 214 may comprise ancillary option data including, but not limited to, a request for additional cards, an emergency credit plan, a long distance calling option or money transfers option.

The account types provided through various embodiments of the invention can vary and the present invention should not be limited to any particular account types. However, for illustrative purposes, the three account types available in one embodiment of the invention are further described. The instant issue card account type provides the customer with an instant issue PIN debit card that can only be used to access loaded funds via ATM transactions. The instant issue PIN debit card is a non-personalized card that may be discarded upon the activation of a branded product. The PIN debit card is maintained at the point of enrollment under physical security conditions that meet all industry requirements prior to issue. The instant issue PIN debit card will be distributed to all customers regardless of any qualification criteria or at minimum, will employ the use of less stringent qualifying criteria. The PIN numbers may be assigned by a vendor process. In addition, customers may be able to obtain an initial PIN in an enrollment kit at the time of purchase or have the PIN mailed per association requirements.

The basic card account type provides the customer with a branded card, i.e. Visa, Master Card, American Express, etc. The delivery and activation of the basic card will be performed in a manner that is consistent with requirements imposed on the delivery of other credit cards. In an exemplary environment, the basic card will be ordered via batch processing and mailed directly to the customer. The basic card will be distributed to all customers regardless of any qualification data or at minimum, will employ the use of less stringent qualifying criteria.

The third account type is the basic card with overdraft protection. This account type is available to customers that meet underwriting criteria. The overdraft component provides additional coverage in case funds in the primary account are depleted. In the preferred embodiment, the overdraft amount is finite and is not revolving. In one embodiment, a use fee may be associated with the overdraft component. In various embodiments, certain rules or requirements for repayment of drafts against the overdraft component are established. One such requirement may be that the overdraft must be repaid within the next business cycle. The business cycle may be any period of time as determined by the issuer, however, in an exemplary embodiment, not more than a 14-day period. In an exemplary embodiment, no additional overdrafts may be permitted once the original overdraft amount is completely utilized for that business cycle. In the event that the overdraft amount and use fees are not paid within the next business cycle, the customer will be assessed penalties and their DDA will be debited for the total amounts owed.

The examples and card categorizations provided herein are for illustrative purposes only and should not be construed as limitations on the present invention. Other card variations could also be employed that either combine one or more features of the embodiments described herein, or include other features not described.

The data or information that is collected in the data collection component 210 may be collected in a variety of ways or at a variety of different location types including, but not limited to, a retail point of sale (“POS”) channel, a check cashiers channel, a payday loan channel, a direct marketing channel, an internet channel, etc.

The POS channel may be a customer or a chain merchant which may be generally located or located in targeted population environments. Account card activation at a POS may be conducted via POS, IVR, Web, a live operator, and may be utilized using an account number and a sealed PIN. To insure consistency, the POS channel may be required to have a POS device with the functionality that supports both loading and re-loading of an account. The POS channels may employ velocity controls to limit both dollar and quantity of sales by each employee and also be required to support pre-funding based on estimated daily sales. In addition, the POS channels may up sell products by use of live operator calls.

The check cashiers channels are merchant locations that have check cashing capabilities. The card account activation process may require a PIN at the time of enrollment or first distribution. Enrollment and distribution of cards may be conducted through issuer provided front end or POS device. The check cashiers channels serve as a continued point of service for consumers after initial enrollment and distribution. In addition, the check cashiers channels must have appropriate storage, handling and accounting controls. The reloading of accounts may be confined to merchant locations participating in a program through Western Union or Money Gram transactions. In addition, check cashiers channels may employ velocity controls to limit both dollar and quantity of sales by each employee and also be required to support pre-funding based on estimated daily sales.

Payday loan channels consist of participating member locations and do not have an associated physical account card. Using an USBFA proprietary system, a consumer may arrange for an advance through a participating member location. Payday loan channel locations would provide the conduit for required documents for underwriting purposes. The approved loan amounts are transferred to consumer held DDA accounts.

The direct marketing channels have multiple entry points including, but not limited to, DRTV rejected applications, take ones, pre-approved solicitations, and other direct marketing means. Offers may be limited to a particular account type, for example, a signature based account only, etc. Loading and re-loading of accounts may be accomplished via direct deposit activity from employer, Western union or Money Gram transfers, with potential for re-load stations in a POS merchant channel. The initial fee collection may be made by submission of money order, wire transfer or other confirmed source of funds.

The internet channels are a logical extension of the direct marketing channels. Internet channels may be limited to a particular account type, for example, a signature based account only, etc. for risk purposes. The account loading may be limited to money orders, wire transfers or other confirmed source of funds. Additional physical reloading may be performed by a program merchant or through an approved direct deposit employer program.

In an exemplary embodiment, the data collection component 210 includes the reception of an initial deposit of funds 216. The initial deposit 216 may be originated by, but not limited to, a point of sale (POS) transaction, pooled funds from a channel partner, a customer DDA from a channel partner, a direct deposit from an employer, wired funds, money order or certified funds via mail, etc. The initial deposit 216 may be loaded or deposited into a funding account and operates in conjunction with the stored value component 232. After the data collection component 210 receives the necessary or the minimum amount of information, the decision engine 220 can be begin processing.

In an exemplary embodiment, the decision engine 220, receives raw or processed data from the data collection component 210 and, among other functions, integrates it with underwriting criteria 222 to determine if a customer qualifies for an account. The underwriting criteria 222 is initially determined using a collection of integrated algorithms, methods of work, business processes, and initial risk modules 224 that enable the analysis, issuance, distribution, and monitoring of an integrated credit product. The initial risk models 224 are compiled from a variety of different sources that vary by issuer and one skilled in the art is familiar with the type of information that is associated with them. In addition to determining if a customer qualifies for an account, the decision engine system 220 also determines if a customer qualifies for any applicable account option data 214 selected in the data collection system 210. For example, if a customer selected an overdraft option in the account option data 214, the decision engine 220 would determine if the customer qualified for that option and, if qualified, the amount of the overdraft limit. The decision engine 220 uses the account formation data 212 to qualify the customer and perform a risk management processes. The customer is subjected to underwriting criteria 222 to determine qualification and some additional data or documents may be required for the process. The underwriting criterion 222 is standard in the industry and known to those skilled in the art.

Once a customer is qualified, the account creation component 230 proceeds to open an account. The account creation component 230 may perform different functions dependent upon the account option data 214. Preferably, the account creation component 230 operates to create an account for the customer in a manner that is in compliance with all applicable local, state and federal laws. During the account creation, the account creation component 230 may utilize various procedures to support issuer risk mitigation requirements. In an exemplary embodiment, the risk mitigation procedures are only instituted for an account with the overdraft component 234 and not the other account types. Those skilled in the art will be aware of the various mitigation procedures and understand that the procedures can vary by each issuer and are commonly known in the art.

The procedures performed by the account creation component 230 may vary depending on the type of account being created. In the examples provided herein, the three account types include the instant issue card, the basic card and the basic card with overdraft protection.

When creating an instant issue card account, depending on the particular implementation, it may or may not require the use of a verification number. The verification number is used to initially enable the account. If a verification number is used, the verification number could be the last 4 digits of the customer's social security number or some other reference number such as, but not limited to, an employee ID number, TIN or other type of number sequence but preferably is not part of the personally selected PIN. It should be noted that in some embodiments, the instant issue card account can be created without requiring any customer information. If a verification number is not used and customer information is not required, the account can simply be created as a result of a customer making an initial deposit 216. Once the initial deposit is made and verified, the customer can access funds immediately via the loaded or deposited funds from the funding account operating in conjunction with the stored value component 232. The amount of any transaction may not exceed the amount of the stored value component 232. An instant issue card account will have a PIN provided for initial use and is only intended to be used in conjunction with ATM transactions.

When creating a basic card account, a minimum amount of account formation data 212 may be required. For example, information such as the customer's name, addresses, and phone numbers may be required. For the basic card account, the basic card is mailed to the customer. The basic account can also be structured in a manner that after a customer makes an initial deposit 216, an instant issue card may be immediately issued to the customer, along with a PIN provided for initial use for ATM transactions while the personal, basic card is sent to the customer in the mail. In some embodiments, the basic card may be branded by a financial company, such as American Express, Visa or Discovery, or by other companies as well. The basic card has a higher level of security requirements than the instant issue card. Thus, the basic card may have a unique PIN that is associated with the card and that is mailed to the customer separately from the basic card itself. In addition, the basic card may require certain activation steps to be performed prior to activating the card for use. Such activation steps can include the customer calling a particular number to verify receipt of the card, using the card at an ATM, or any other applicable action. The basic card may be used for both PIN based and off-line or signature based transactions. The card value is based upon the initial deposit 216; however the card may be re-loaded by the account management system 240.

When creating a basic card account with an overdraft component 234, a heightened amount of account formation data 212 may be required. For example, in addition to the information required for the basic card account, the basic card account with an overdraft component 234 may also require the provision of the customer's social security number, government identification, direct deposit account (DDA) information, savings account information, etc. Although the overdraft component 234 is described as being available in conjunction with the basic card, the overdraft component 234 can also be available separate from the basic card. When the overdraft component is included with the basic card, all of the basic card requirements apply with the additional requirements for the overdraft component 234.

For accounts that qualify for the overdraft component 234, the allowable or authorized overdraft amount must be determined. The decision engine 220 operates to make this determination. The account creation component 230 receives this information from the decision engine 220 and operates in conjunction with the stored value component 232 to provide the overdraft component 234. In operation, the overdraft component 234 allows the customer to perform transactions that exceed the customer's loaded or deposited funds in the funding account or stored value component 232 to the extent of the overdraft amount.

Another function that the account creation component 230 may include is the activation of the account. In the account creation component 230 a channel partner or live customer service agent may activate the instant issue PIN debit card after the initial deposit 216 has been provided and just before the card is issued to the customer. The basic card and basic card with overdraft accounts are typically activated at other times via telephone or use.

The account creation component 230 also operates to perform the card issuance. With regards to an instant issue card account, an instant issue PIN debit card is issued to the customer immediately following the initial deposit 216 and the activation of the card. This may be performed by a merchant, a customer service representative, or other similar entity. With regards to the basic card account, an instant issue PIN debit card is issued to the customer first and after the qualification process, the instant issue PIN debit card can immediately be used. Next, a basic card will be ordered via batch processing and delivered to the customer—typically through a direct mailing. A PIN that is used to activate the basic card is mailed to the customer separate from the card for security reasons. In one embodiment, the account can be given an expiration date, such as 24 months from issuance, at which time the account is deactivated. The expiration date can be embossed on the card. The account management component 240 manages the customer account by utilizing controllers to enable and disable certain functions and privileges of the account based on various factors. Some of the factors can include account risks and customer behaviors. In one embodiment, the account management component 240 can include the functions of fraud management model 242, fee management model 244 and account behavior model 246. The fraud management model 242 can utilize the operation of the account behavior model 246 to determine if any fraudulent activities are associated with the account. If any fraudulent activities are detected, the account management component 240 can be notified by the fraud management model 242 to suspend the account. The fee management model 244 determines and assesses any applicable fees to be charged against the account. For example, if the account is overdue, a late fee would be assessed to the account. In the various embodiments, additional fees can be assessed against the accounts. For instance, a one time fee may be assessed for the creation of the account or for the creation of certain accounts, such as accounts having an overdraft component 234. In addition, the account may include a fixed number of transactions or a fixed number of transactions per fixed period (i.e. per month). Once the fixed number of transactions is exceeded, additional transactions can be assessed a transaction fee. In another embodiment, a monthly fee may be assessed on the account.

The account behavior model 246 examines account activity and looks for patterns in the account activity to determine possible actions to be taken (i.e. intervention to stop fraud). For example, if an account appeared to have sporadic spending or if the stored value became zero, the account could be turned off temporarily to ascertain if the account is being defrauded.

The transactional processing component 250 processes and monitors the day to day transactions between the account and the financial transaction network 255. The transactional processing component 250 is then compiled and its data is aggregated 252. The aggregation of data 252 may be by an entire population or by a group of populations that are grouped in accordance with various attributes such as age, income, occupation, location, or the like.

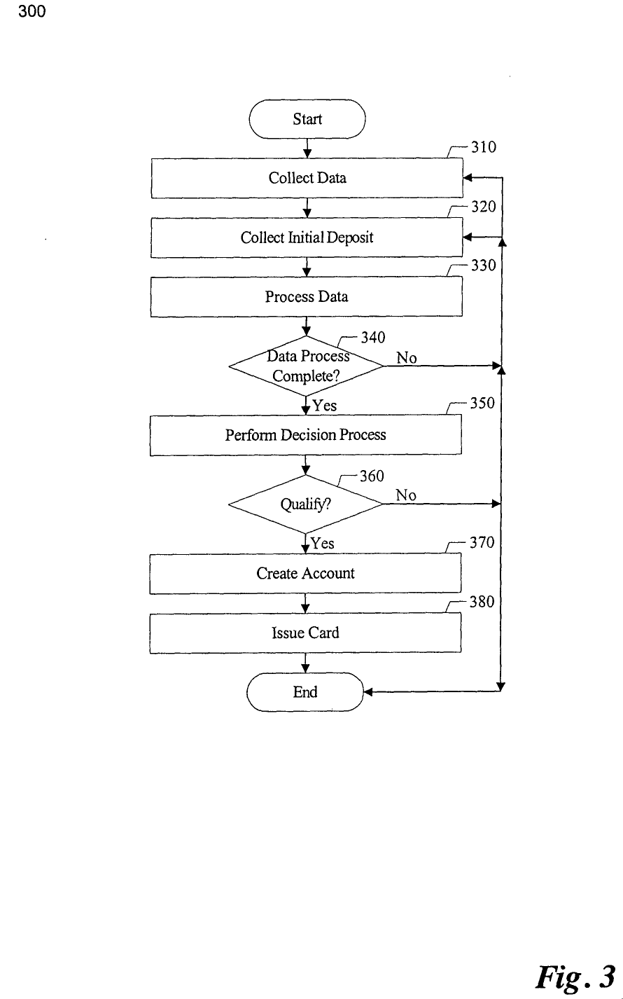

FIG. 3 is a flow diagram 300 illustrating an exemplary embodiment of the present invention depicting a method for creating an account. The details of the operation of the flow diagram for creating an account 300 may vary among various embodiments of the present invention. In an exemplary embodiment, the first step is collecting data 310. The data collection step 310 collects data or information relevant to opening a credit account or account formation data including, but not limited to, name, date of birth, address, telephone, social security number, verified government identification, direct deposit account (DDA) information and number, savings account information and number, credit history, debt to credit ratio, assets, marital status, employment history etc. In addition to account formation data collected in the data collection step 310, account option data may also be collected.

The account option data comprises account option data chosen by the customer, which, in an exemplary embodiment, dictates an account type. In an exemplary embodiment, the account option data may include, but is not limited to, an instant issue card account, a basic card account and a basic card account with an overdraft component. Additionally, the account option data may also comprise ancillary option data including, but not limited to, additional cards, an emergency credit plan, long distance calling or money transfers. In an exemplary embodiment, the account option data will contain an access card type, i.e. instant issue card, basic card or a card with the overdraft component, and any number of ancillary options. The next step is to collect an initial deposit 320.

Collecting the initial deposit 320 may be originated by, but not limited to, a point of sale (POS) transaction, pooled funds from a channel partner, a customer DDA from a channel partner, a direct deposit from an employer, wired funds, money order or certified funds via mail, etc. The initial deposit 320 may be loaded or deposited into a funding account. Thus, when an access card issues in the card issuance step 380, it is pre-loaded with the initial deposit 320.

The next step is to process the data at step 330. In this step the data is collected and checked for completeness and accuracy. If the data is not accurate or complete, the data process complete step 340 will send the process back to the step where the process was incomplete or inaccurate. If the data is complete and accurate, the data process complete step 340 will send the process to the next step of performing decision process 350.

The decision process step 350 receives the data from the data processing step 330 and integrates it with underwriting criteria to determine if a customer qualifies for an account. The underwriting criteria is initially determined using a collection of integrated algorithms, methods of work, business processes, and initial risk modules that enable the analysis, issuance, distribution, and monitoring of an integrated credit product. The initial risk models are compiled from a variety of different sources that vary by issuer and one skilled in the art is familiar with the type of information that is associated with them. In addition to determining if a customer qualifies for an account, the decision process also determines if a customer qualifies for any applicable account options selected in the data collection step 310. For example, if a customer selected an overdraft option, the decision process 350 would determine if the customer qualified for that option and, if qualified, the amount of the overdraft limit. If the customer does not qualify 360 for an account, more data may be collected 310, an additional initial deposit may be collected 320, the process may terminate or some other result may be performed. If the customer does qualify 360 for an account, the process proceeds to the create account 370 step.

The create account 370 step may vary depending on the option data as discussed above. During the create account 370 step, the customer's account is created in compliance with all applicable local, state and federal laws.

The next step is issuing a card 380. In an exemplary embodiment, with an instant issue card account, an instant issue PIN debit card is issued to the customer immediately following an initial deposit 320 and the activation of the card. This may be performed by a merchant, a customer service representative, or a similar entity. In an exemplary embodiment, with a basic card account, first, an instant issue PIN debit card is issued to the customer after the decision process 350 and the customer qualifies 360 to be used immediately. Next, a basic card will be ordered via batch processing and mailed directly to the customer. A PIN will be mailed to the customer separately to activate the basic card. In an exemplary embodiment, the account will have an expiration date, preferably set 24 months from issuance, which may be embossed on the card itself.

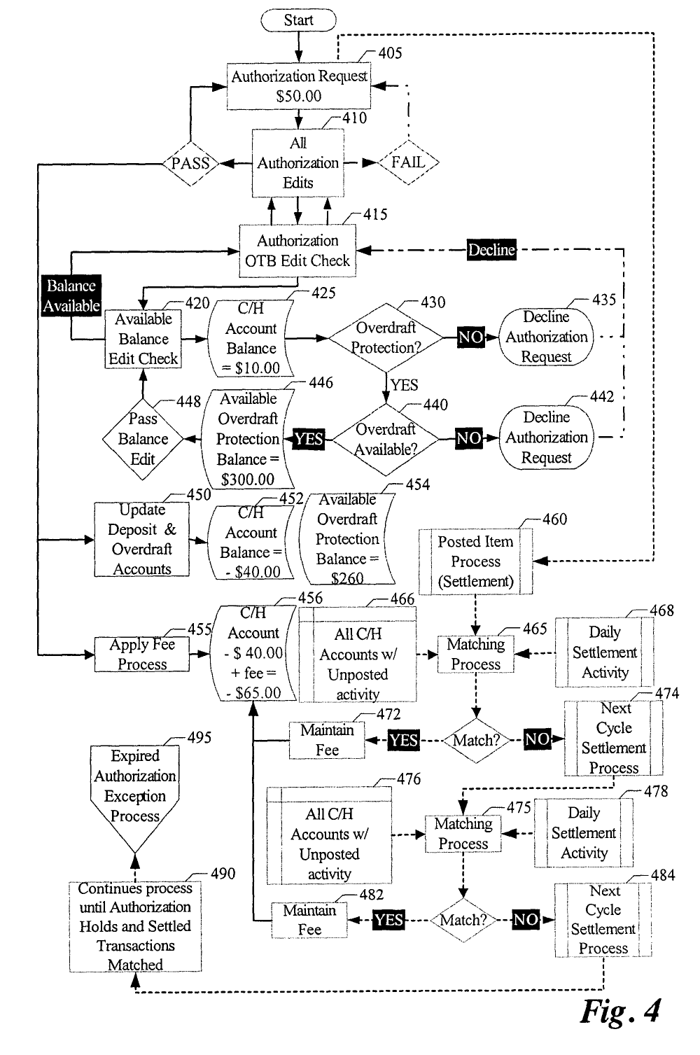

FIG. 4 is a flow diagram that illustrates the operation of performing a transaction 400 according to an exemplary embodiment of the present invention. The details of the operation of the transaction 400 may vary among various embodiments of the present invention. As an illustrative example of an exemplary embodiment, assume a customer has opened a basic card account which has a current balance of $10 and an overdraft option with a limit of $300. In an exemplary embodiment, the first step of transaction 400 is receiving an authorization request 405 requesting a $50 withdrawal. The authorization request 405 may be made through a variety of different sources including but not limited to, ATM, automated telephone services, in-person customer service representative, phone customer service representatives or a website. Next, an all authorization edits 410 step is performed.

The all authorization edits 410 step authorizes the transaction. If the all authorization edits 410 step fails, the process returns to the authorization request 405 step and waits for another authorization request. If the all authorization edits 410 step passes, the process proceeds to update the deposit and overdraft accounts, step 450, and applies any applicable fees, step 455. The first step in the all authorization edits 410 process is the authorization open to buy (OTB) edit check 415 step. This step checks to see if there are available funds. The first step in the authorization open to buy (OTB) edit check 415 step is performing an available balance check, step 420, in this example the account balance 425 is $10. The process then checks to see if the account has overdraft protection at step 430. If the account has overdraft protection 430, the process checks if overdraft funds are available at step 440. If the account does not have overdraft protection at step 430, the authorization request is declined at step 435 and the process returns to the authorization OTB edit check 415 step. If overdraft funds are available at step 440, the available overdraft protection balance is checked at step 446, in this example $300. If overdraft funds are not available at step 440, the authorization request is declined at step 442 and the process returns to the authorization OTB edit check 415 step. After the available overdraft protection balance at step 446 is checked and the enough funds are available, in this example $300, a pass balance edit 448 is returned to the available balance edit check at step 420. At this point, a balance available is returned to the authorization OTB edit check 415. The authorization OTB edit check 415 step then returns either a fail (from step 435 or step 442) or a pass (from step 420) back to the all authorization edits 410 step. Again, if the all authorization edits 410 step fails, the process returns to the authorization request 405 step and waits for another authorization request and if the all authorization edits 410 step passes, the process proceeds to update the deposit and overdraft accounts, step 450, and applies any applicable fees, step 455.

Next, the process updates the deposit and overdraft accounts at step 450. Next, the account balance is checked at step 452, in this example the account balance is now (−$40) which represents the $10 account balance minus the $50 request. The available overdraft protection balance is also checked at step 454, here the overdraft balance is $260 which represents the original $300 overdraft balance minus the $40 over drafted from the account during the $50 request. Next, any applicable fees are applied at step 455, in this example a $25 fee is assessed for the overdraft protection. Next, a new account balance is checked at step 456, in this example the account balance is (−$65) representing the account balance of (−$40) from step 452 minus the fee of $25 at step 455.

Next, a posted item process (settlement), step 460, posts the item for settlement and continues to the matching process at step 465. The matching process at step 465 attempts to match all accounts with un-posted activity 466 with the daily settlement activity 468. If there is a match, a maintenance fee at step 472 is assessed and is subtracted from the account at step 456. If there is not a match, the process goes to the next cycle settlement process 474. The process then repeats by going through another matching process 475 attempting to match all accounts with un-posted activity 476 with the daily settlement activity 478. If there is a match, a maintenance fee 482 is assessed and is subtracted from the account at step 456. If there is not a match, the process goes to the next cycle settlement process 484. The process then continues until authorization holds and settled transactions are matched at step 490. After the authorization holds and settled transactions are matched 490 if no match is found, the process ends at the expiration authorization exception process 495.

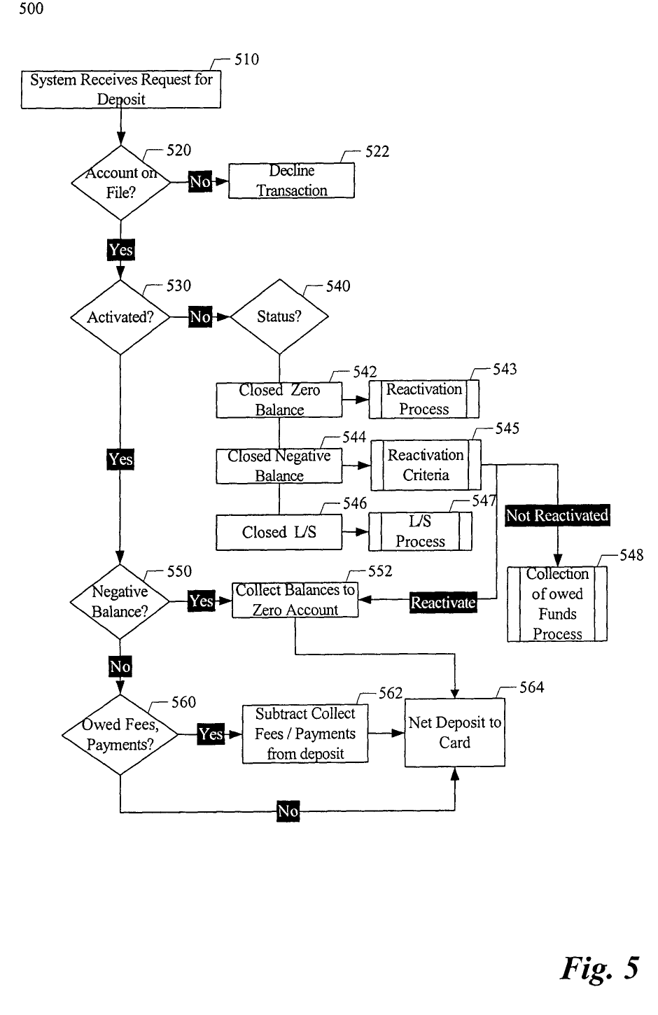

FIG. 5 is a flow diagram illustrating an exemplary embodiment of the present invention depicting a deposit transaction 500. The details of the operation of the deposit transaction 500 may vary among various embodiments of the present invention. The system receives a request for a deposit at step 510, the request may be made through a variety of different sources including but not limited to, ATM, automated telephone services, in-person customer service representative, phone customer service representatives or a website. After the system receives a request for a deposit at step 510, a check is performed to see if an account is on file at step 520. If no account is on file at step 520, the transaction is declined at step 522. If an account is on file at step 520, a check is performed to see if the account on file has been activated at step 530.

If an account is not activated at step 530, then the process checks for a status at step 540. When the process checks for a status at step 540, it looks for a closed zero balance status at step 542, a closed negative balance status 544 or a closed lost/stolen (L/S) status 546. If a closed zero balance 542 is found, it continues to a reactivation process at step 543. If a closed negative balance 544 is found, processing continues to examine reactivation criteria at step 545 to determine if the account should be reactivated. After the reactivation criteria step 545 has been examined and a determination is made to reactivate the account, owed funds are collected from the deposit to balance the account to zero at step 552. The zeroed account is updated and reflected to the net deposit of the card 564. After the reactivation criteria 545 are examined and a determination is made to not reactivate the account, a collection of owed funds process begins at step 548. If a closed L/S status 546 is found, it continues to a L/S process 547.

If an account is activated 530, then the process checks for a negative balance 550. If a negative balance 550 does exist, a collection balances the account to zero 552. If a negative balance 550 does not exist, the process checks for owed fees or payments due 560. If owed fees or payments are due 560 they are subtracted from the deposit 562 and the net is deposited to the card 564. If owed fees or payments are not due 560, the net is deposited to the card 564.

One skilled in the art will appreciate that the application of the present invention can take many forms and function and the examples provided herein are only used to illustrate a few of these possibilities. The scope of the present invention is not limited by these examples.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Although this disclosure describes the invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A method for providing a financial account service, the method comprising the steps of:
creating a funded financial account;
issuing a transaction card, the transaction card being operable to be used in financial transactions and is associated with the funded financial account;
receiving a financial transaction request based on the use of the transaction card; and
clearing the financial transaction utilizing the funded financial account.

2. The method of claim 1, wherein the funded financial account is associated with a particular customer and the step of creating the funded financial account further comprises the step of depositing funds received from the particular customer into the funded financial account.

3. The method of claim 1, wherein the funded financial account is associated with a particular customer and the step of creating the funded financial account further comprises the steps of:
qualifying the particular customer;
receiving funds from the particular customer; and
depositing the funds received from the particular customer into the funded financial account.

4. The method of claim 3, wherein the step of receiving funds from the particular customer further comprising the steps of:
gaining access to a direct deposit account of the particular customer; and
extracting the funds from the direct deposit account.

5. The method of claim 4, further comprising the steps of:
providing a line of credit that can be drawn against by the particular customer;
establishing payment performance requirements for the line of credit; and
extracting funds from the direct deposit account to cover an outstanding balance if the particular customer fails to meet the payment performance requirements.

6. The method of claim 1, wherein the funded financial account is associated with a particular customer and the step of creating the funded financial account further comprises the steps of:
qualifying the particular customer;
gaining access to a direct deposit account of the particular customer;
extracting the funds from the direct deposit account; and
depositing the funds received from the particular customer into the funded financial account.

7. The method of claim 1, wherein the funded financial account is associated with a particular customer and the step of creating the funded financial account further comprises the steps of:
receiving funds from the particular customer at a point of sale terminal; and
depositing the funds received from the particular customer into the funded financial account.

8. The method of claim 1, wherein the funded financial account is associated with a particular customer and the step of creating the funded financial account further comprises the steps of:
receiving funds from the particular customer through the mail; and
depositing the funds received from the particular customer into the funded financial account.

9. The method of claim 1, wherein the funded financial account is associated with a particular customer and the step of creating the funded financial account further comprises the steps of:
gaining access to a direct deposit account of the particular customer;
extracting the funds from the direct deposit account; and
depositing the funds received from the particular customer into the funded financial account.

10. The method of claim 1, wherein the funded financial account is associated with a particular customer and the step of creating the funded financial account further comprises the steps of:
gaining access to a direct deposit account for the particular customer;
providing a line of credit that can be drawn against by the particular customer;
establishing payment performance requirements for the line of credit;
and
extracting funds from the direct deposit account to cover an outstanding balance if the particular customer fails to meet the payment performance requirements.

11. The method of claim 1, wherein the step of issuing a transaction card further comprises the step of issuing a branded transaction card.

12. A system for providing a checkless checking account, comprising:
a data collection component, wherein said data collection component is operable receive account option data, account formation data and an initial deposit;
a decision engine operable to qualify a customer for an account based at least in part on said formation data and said account option data;
an account creation component operable to establish an account for the qualified customer based at least on part on the account option data and account formation data and to create a transaction card;
a transactional processing component operable to receive transactions initiated with the transaction card and clear the transactions against the account.

13. The system of claim 12, wherein the initial deposit is placed into a stored value component.

14. The system of claim 13, wherein said account further comprises an overdraft component, wherein said overdraft component is coupled to said stored value component.

15. The system of claim 14, wherein said overdraft component has a value that is determined by said decision engine.

16. A method for providing a checkless checking account, comprising the steps of:
receiving account option data;
receiving account formation data, wherein said account formation data is based upon said account option data;
determining an account type based at least in part upon said account option data and said account formation data;
creating an account, wherein said account is based upon said account type;
receiving funds into a stored value component; and
providing an account access card, wherein said access card is based upon said account option data and has an associated value based upon said stored value component.

17. The method of claim 16, wherein said stored value component may be modified by the step of receiving additional funds.

18. The method of claim 16, further comprising the steps of:
receiving a transaction request for a cash withdrawal from an authorized automated teller machine utilizing the account access card;
clearing the transaction; and
rejecting any other type of transaction.

19. The method of claim 16, further comprising the steps of:
receiving a transaction request for a financial transaction utilizing the account access card; and
clearing the transaction.

20. The method of claim 19, wherein said stored value component is coupled with an overdraft component and further comprising the steps of:
qualifying a customer for said overdraft component; and
qualifying a customer for a value coupled to said overdraft component.
